(19) United States
(12) Patent Application Publication
(10) Pub. No.: US 2011/0016100 A1
(43) Pub. Date: Jan. 20, 2011

(54) MULTIPLE FIDELITY LEVEL ITEM REPLICATION AND INTEGRATION

(75) Inventors: Venugopalan Ramasubramanian, San Francisco, CA (US); Thomas L. Rodeheffer, Mountain View, CA (US); Douglas B. Terry, San Carlos, CA (US); Kaushik Veeraraghavan, Ann Arbor, MI (US); Edward P. Wobber, Menlo Park, VA (US)

Correspondence Address: MICROSOFT CORPORATION, ONE MICROSOFT WAY, REDMOND, WA, 98052, US

(73) Assignee: Microsoft Corporation, Redmond (US)

(21) Appl. No.: 12/503,871

(22) Filed: Jul. 16, 2009

(51) Int. Cl. G06F 17/30

(52) U.S. Cl. 707/695; 707/E17.007

(57) ABSTRACT

A distributed system synchronizes replica devices with respect to items that may be inserted, modified, or deleted by any of the replica devices. Replicas may synchronize with other replicas to learn about updates to items. Each replica device may include a high-fidelity replication platform and/or a low-fidelity replication platform. The low-fidelity replication platforms may synchronize low-fidelity versions of items among the replica devices, and the high-fidelity replication platforms may synchronize high-fidelity versions of items among the replica devices. Each replica device may include a fidelity manager that copies high-fidelity versions of items from the high-fidelity replication platform, generates low-fidelity versions of the items from the high-fidelity versions of the items, and adds the low-fidelity versions of the items to the low-fidelity replication platforms. The fidelity managers may further integrate changes made to low-fidelity versions of items into the corresponding high-fidelity versions of the items.

### BACKGROUND

A system may include a collection of computing devices, where a data item may be replicated to create a number of copies of the item on the different computing devices and/or within a single device. An item may be any stored data object, such as for example contact or calendar information, stored pictures or music files, software application programs, files or routines, etc. The collection of computing devices may for example comprise a desktop computer, a remote central server, a personal digital assistant (PDA), a cellular telephone, etc. The items and computing devices (“replica devices”) where the items are stored may be referred to as a distributed collection.

Replication, or synchronization, of data is a process used to ensure that each replica device has the same information. Synchronization protocols are used by replica devices that exchange created and updated versions of items in order to bring themselves into a mutually consistent state. The periodicity of the synchronization may vary greatly. Networked replica devices may synchronize with each other frequently, such as once every minute, hour, day, etc. Alternatively, non networked replica devices may synchronize infrequently, such as for example portable devices. Whether the synchronization is frequent or infrequent, the distributed collection is said to be weakly consistent in that, in any given instant, replica devices may have differing views of the collection of items because items updated at one replica device may not yet be known to other replica devices.

Synchronization between replica devices may be described as a sharing of knowledge between the replica devices. A common synchronization scheme involves tracking, within each replica device, changes that have occurred to one or more items subsequent to a previous synchronization. One such tracking scheme makes use of version vectors, which may include a list of version numbers, one per replica device, where each version number is an increasing count of updates made to an item by a replica device.

Often the various replica devices process and update data items at different levels of fidelity. For example, a PDA may support less fields or elements of a contact file than a full featured desktop computer replica device. A version of an item that does not support all available fields or elements may be referred to as a low-fidelity item and a version of an item that supports all fields or elements may be referred to as a high-fidelity item. Similarly, a replica device that supports less than all available fields or elements of an item may be referred to as a low-fidelity replica device, and a replica device that supports all available fields or elements of an item may be referred to as a high-fidelity replica device. When a most recent update to a data item happens on a low-fidelity replica device, the updated low-fidelity version of the item may replace the high-fidelity version of the item in the collection during the synchronization process based on the version vector of the low-fidelity version of the item. This is often undesirable because the high-fidelity version of the item may contain valuable information in unsupported fields that is lost during the synchronization process even though the update at the low-fidelity replica device could not have updated the unsupported fields.

### SUMMARY

A distributed system synchronizes a set of replica devices with respect to a set of items that may be inserted, modified, or deleted by any of the replica devices. Replicas may occasionally synchronize with other arbitrarily chosen replicas to learn about updates to items. Each replica device may include one or both of a high-fidelity replication platform and a low-fidelity replication platform. The low-fidelity replication platforms may synchronize low-fidelity versions of items among the replica devices, and the high-fidelity replication platforms may synchronize high-fidelity versions of items among the replica devices. Each replica device may further include a fidelity manager that copies high-fidelity versions of items from the high-fidelity replication platform, generates low-fidelity versions of the items from the high-fidelity versions of the items, and adds the low-fidelity versions of the items to the low-fidelity replication platforms. The fidelity managers may integrate changes made to low-fidelity versions of items into the corresponding high-fidelity versions of the items. While the fidelity of the items are described as either high-fidelity or low-fidelity, it is for illustrative purposes only; there is no limit to the number of fidelity levels that may be supported.

In some implementations, a first version and a second version of an item may be identified at a fidelity manager. The first version of an item may have a greater fidelity than the second version of the item and the second version of the item may be more recently updated than the first version of the item. Elements in the first version of the item that are not in the second version of the item may be determined at the fidelity manager. A third version of the item may be generated at the fidelity manager by merging the elements of the second version of the item with the determined elements of the first version of the item that are not in the second version of the item. The third version of the item may have the fidelity of the first version of the item.

The first version of the item may be a high-fidelity item and the second version of the item may be a low-fidelity item. The first version and the second version of the item may each have an associated fidelity tag that identifies the elements in the item, and determining elements in the first version of the item that are not in the second version of the item may include comparing the fidelity tag of the first version of the item with the fidelity tag of the second version of the item.

A first tagged version vector may be associated with the first version of the item and a second tagged version vector may be associated with the second version of the item. Each tagged version vector may include a count value and fidelity value for each replica device of a group of replica devices. The count value for a replica device may define the number of updates made by the replica device to the corresponding version of the item, and the fidelity value for a replica device may define the fidelity at which the most recent update was made by the replica device.

A third tagged version vector may be generated for the generated third version of the item by, for each count value in the first version vector, comparing the count value in the first version vector with the count value in the second version vector corresponding to the same replica device. If the count value is higher in the first version vector, then the count value and the fidelity value from the first version vector are used in the third version vector, and if the count value is higher in the second version vector, then the count value and the fidelity value from the second version vector are used in the third version vector.

In some implementations, a first version of an item may be received at a fidelity manager from a first-fidelity level replication platform. The first version of the item may have an associated first-fidelity level tag and a first tagged version vector. A tagged version vector may include a count value and fidelity value for each of a group of replica devices. The count value for a replica device may define the number of updates made by the replica device to the first version of the item and the fidelity value for a replica device may define the fidelity at which the most recent update was made by the replica device. A second version of the item may be generated from the first version of the item. A second-fidelity level tag may be associated with the second version of the item.

A second tagged version vector may be generated from the first tagged version vector. The second tagged version vector may be associated with the generated second version of the item. The generated second version of the item may be provided to a second-fidelity level replication platform. The second version of the item may be received from the second-fidelity level replication platform. The first version of the item may be integrated into the second version of the item.

A first-fidelity level tag may be associated with the second version of the item. The second version of the item may be provided to the first-fidelity level replication platform. The first-fidelity level tag may identify a plurality of elements of the first version of the item and the second-fidelity level tag may identify a plurality of elements of the second version of the item. Integrating the first version of the item into the second version of the item may include determining from the first-fidelity level tag and the second-fidelity level tag the elements of the first version of the item that are not part of the second version of the item, and integrating the determined elements into the second version of the item. The first tagged version vector may be merged with the second tagged version vector to create a third tagged version vector.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there are shown in the drawings example constructions of the embodiments; however, the embodiments are not limited to the specific methods and instrumentalities disclosed. In the drawings:

FIG. 1 is an illustration of an exemplary environment for providing fidelity-aware replication;

FIG. 2 is an illustration of exemplary fidelity tags;

FIG. 3 is an illustration of another exemplary environment for providing fidelity-aware replication;

FIG. 4 is an illustration of an exemplary process for transforming a high-fidelity version of an item into a low-fidelity version of the item;

FIG. 5 is an illustration of an exemplary process for integrating changes made to different versions of an item; and

FIG. 6 is a block diagram of a computing system environment according to an implementation of the present system.

### DETAILED DESCRIPTION

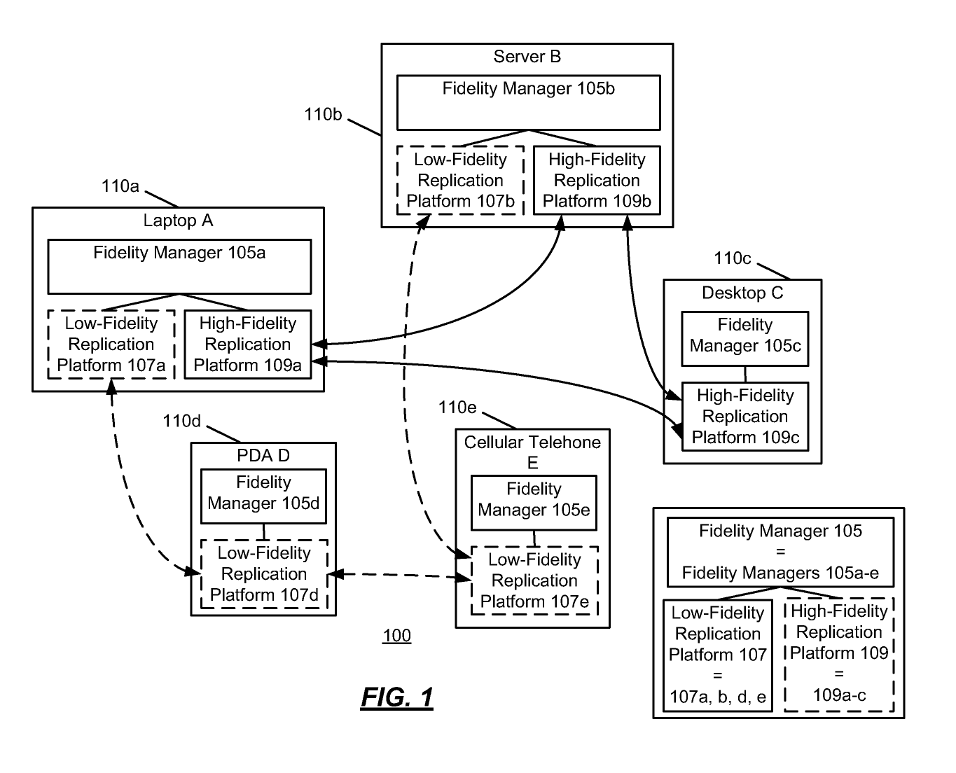

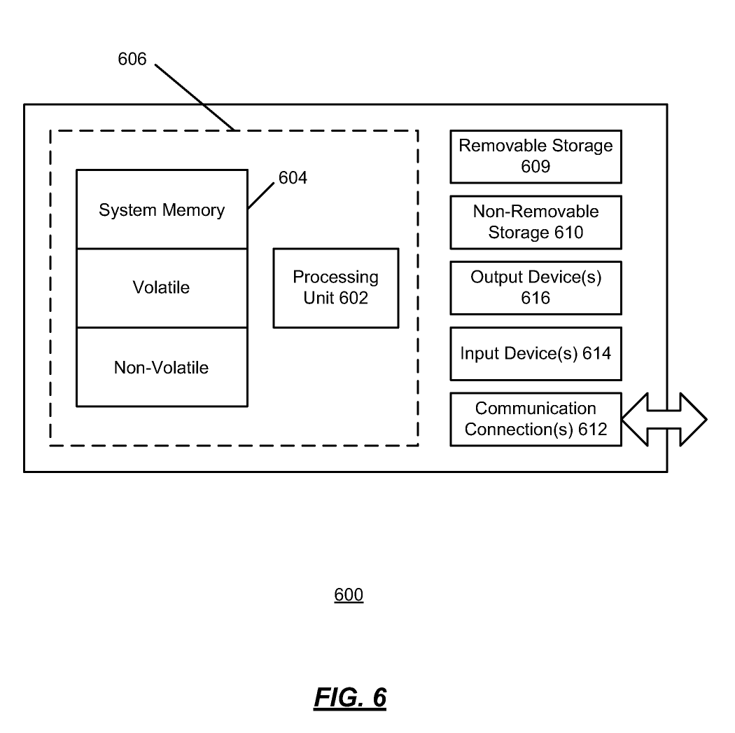

FIG. 1 is an illustration of an exemplary environment 100 for providing fidelity-aware replication. The environment 100 includes a plurality of replica devices 110a-110e (also referred to as replicas). The replica devices 110a-110e include a laptop 110a, a server 110b, a desktop 110c, a personal digital assistant (PDA) 110d, and a cellular telephone 110e, respectively. Each replica device 110a-110e may be implemented using a general computing device such as the computing device 600 described with respect to FIG. 6. While only five replica devices 110a-110e are illustrated, it is for illustrative purposes only; there is no limit to the number of devices that may be supported by the environment 100. Moreover, the environment 100 is not limited to the types of devices chosen for the replica devices 110a-110e. The replica devices 110a-110e may include a wide variety of computing devices, including set top boxes, video game devices, digital cameras, portable music players, etc.

The environment 100 is an example of a topology-independent weakly consistent replication environment. A weakly consistent replication environment may replicate a collection of items on each of the replica devices 110a-110e. The items may include a variety of file types, including, but not limited to image files, video files, document files, software and application files, and contact files, for example. A topology-independent environment does not have a client-server hierarchy and does allow peer-to-peer synchronization.

Each of the replica devices 110a-110e may create, delete, or modify an item from the collection of items. For purposes of convenience, the term “update” may be used to refer to these operations or any other operation that may be performed on an item or file. In a weakly consistent system like the environment 100, updates may be made by users at the various replica devices 110-110e, even when those devices are disconnected or not synchronizing. Thus, the environment 100 eventually converges to a consistent state, but at any time may have one or more items that are inconsistent.

Each of the replica devices 110a-110e may periodically synchronize with respect to one another. During synchronization, one of the replica devices 110a-110e may transmit information to the other of the replica devices 110a-110e describing the changes that the replica device knows were made to the items in the collection of items. The synchronization may be scheduled (e.g., hourly, daily, etc.), or may be opportunistic. For example, the PDA 110d may synchronize with the laptop 110a when placed in a dock or cradle. As another example, the cellular phone 110e may synchronize with the server 110b whenever the cellular phone 110e updates an item. The replica devices 110a-110e may communicate with each other in an ad hoc, peer-to-peer network via communication links (represented by dashed lines and solid lines in FIG. 1) between the various replica devices 110a-110e. The illustrated communication links can be wired and/or wireless links, and may or may not include the Internet, a LAN, a WLAN or any of a variety of other networks.

The environment 100 may provide for fidelity-aware replication of items. An item may be described as containing a set of elements. For example, a typical contact file may include elements including “Name”, “Address”, “Phone”, “Picture”, and “Resume”. In an implementation, a high-fidelity contact file may be a contact file that supports all of the available elements of an item type. Similarly, a low-fidelity contact file may be a contact file that does not support all of the above described elements. For example, a low-fidelity contact file may only support the “Name”, “Address”, and “Phone” fields, but not the “Picture” and “Resume” fields. A high-fidelity item may be defined as an item that includes all of the elements that available for a particular item type. A low-fidelity item may be defined as an item that includes only a subset of all the elements that are available for a particular item type. While fidelity is described herein in terms of high-fidelity and low-fidelity, there may be multiple fidelity levels (e.g., two or more fidelity levels) supported by the environment 100. The number of fidelity levels supported may be dependent on the type of item and the device type.

Each of the replica devices 110a-110e may support a fidelity level and expose items of that fidelity level to applications executing at the replica devices 110a-110e. For example, the cellular phone 110e and PDA 110d may only support low-fidelity contact files. Thus, a user using the cellular phone 110e and PDA 110d may only view low-fidelity contacts (e.g., contact files that do not support the resume or photo elements). Similarly, in an example, the desktop 110c, the laptop 110a, and the server 110b may allow a user to view high-fidelity contacts (e.g., contacts that support all of the contact file elements).

In some implementations, the replica devices 110a-110e may include separate replication platforms for each fidelity level that they support. The replica devices that support high-fidelity items may each include a high-fidelity replication platform. The replica devices that support low-fidelity items may include a low-fidelity replication platform. The replica devices that support both high and low-fidelity items may include both a high-fidelity replication platform and a low-fidelity replication platform. As illustrated, the cellular phone E and the PDA 110d each include a low-fidelity replication platform 107e and 107d, respectively, the desktop 110c includes a high-fidelity replication platform 109c, and the laptop 110a and the server 110b each include a high-fidelity replication platform 109a and 109b, respectively, and a low-fidelity replication platform 107a and 107b, respectively. Note that each replica device 110 may include a replication platform corresponding to each fidelity level that the replica device 110 supports. Thus, in an environment with seven fidelity levels for example, there may be a replication platform for each of the seven fidelity levels supported. Moreover, each replication platform may be implemented using a variety of known replication platforms, for example.

The high-fidelity replication platform 109 synchronizes high-fidelity items between the replica devices 110a-110e. The low-fidelity replication platform 107 synchronizes low-fidelity items between the replica devices 110a-110e. The communication links between the low-fidelity platforms 107a, 107b, 107d, and 107e are represented in FIG. 1 by the dashed lines connecting the low-fidelity replication platforms 107a, 107b, 107d, and 107e. Similarly, the communication links between the high-fidelity replication platforms 109a, 109b, and 109c are represented in FIG. 1 by the solid lines connecting the high-fidelity replication platforms 109a, 109b, and 109c.

The high-fidelity replication platforms 109a, 109b, and 109c and the low-fidelity replication platforms 107a, 107b, 107d, and 107e may respectively expose high and low-fidelity items to one or more application executing at the replica devices 110a-110e. For example, an email application executing at the desktop 110c may access high-fidelity contacts from the high-fidelity replication platform 109. Where a particular one of replica devices 110a-110e includes a high-fidelity replication platform and a low-fidelity replication platform, separate copies of the item collections may be maintained for each platform. For example, the server 110B may maintain both a low-fidelity item collection and a high-fidelity item collection.

To unify the high- and low-fidelity replication platforms, the replica devices 110a-110e may further include fidelity managers 105a-105e, respectively. In some implementations, the fidelity manager 105 may copy items from the high-fidelity replication platform 109 to the low-fidelity replication platform 107, and copy items from the low-fidelity replication platform 107 to the high-fidelity replication platform 109. The fidelity manager 105 may further ensure that updates made to a low-fidelity version of an item are integrated into the high-fidelity version of the item, while maintaining the elements of the high-fidelity version of the item. As described previously, there may be more fidelity levels supported than high and low, and there may be a corresponding number of replication platforms for each level of fidelity supported. In such implementations, the fidelity manager 105 may copy items among the various fidelity levels supported and integrate updates to an item among the various fidelity level versions of the item.

For example, a user at the laptop 110a may generate a high-fidelity item, such as a contact file. During synchronization, the high-fidelity replication platform 109a at the laptop 110a may transmit the high-fidelity contact file to the high-fidelity replication platforms 109b and 109c at the server 110b and the desktop 110c, respectively, as part of the synchronization process. The fidelity manager 105 may detect or identify the creation of the high-fidelity contact file or may receive the newly created high-fidelity contact file from the high-fidelity replication platform 109. The fidelity manager 105 may then invoke an application or process to convert the high-fidelity contact file to a low-fidelity contact file. The application or process may be specific to the type of item. In some implementations, the high-fidelity contact file may be used to generate a low-fidelity contact file by removing the elements from the high-fidelity contact file that are not supported by the low-fidelity contact file. The fidelity manager 105 may provide the low-fidelity version of the contact file to the low-fidelity replication platform 107, which may then provide the low-fidelity version of the contact file to the low-fidelity replication platform 107d of the PDA 110d as part of the synchronization process, for example.

As described above, the fidelity manager 105 may further ensure that updates made to a low-fidelity version of an item are integrated into the high-fidelity version of the item and vice versa. For example, a user of the PDA 110d may make a change to the low-fidelity version of the contact file described above. As part of the synchronization process, the low-fidelity replication platform 107d at the PDA 110d may provide the updated low-fidelity contact file to the low-fidelity replication platform 107a at the laptop 110a. The low-fidelity replication platform 107a may either provide the updated low-fidelity version of the contact file to the fidelity manager 105a of the laptop 110a, or the fidelity manager 105a may identify the updated version of the low-fidelity contact file at the low-fidelity replication platform 107a. The fidelity manager 105a may then integrate the changes made to the low-fidelity version of the contact file into the high-fidelity version of the contact file by determining the fields or elements of the high-fidelity version of the contact file that are not in the low-fidelity version of the contact file, and may generate a new high-fidelity version of the contact file by merging the determined elements into the low-fidelity version of the contact file. The new high-fidelity version of the contact file may then be provided to the high-fidelity replication platforms 109b and 109c of the server 110b and the desktop 110c, respectively, as part of the synchronization process.

In order to provide for the integration and replication of high-fidelity and low-fidelity versions of items, the fidelity manager 105 may associate metadata with the items. The metadata may be attached and stored with the items at the low-fidelity replication platform 107 and high-fidelity replication platform 109, and/or may be stored separately by the fidelity manager 105 in a database or other data structure, for example.

In some implementations, the metadata may include a fidelity tag. A fidelity tag may be a label describing a fidelity level of an item. In other implementations, a fidelity tag may be a bit vector or other data structure where a bit may be set for each element that is part of the item.

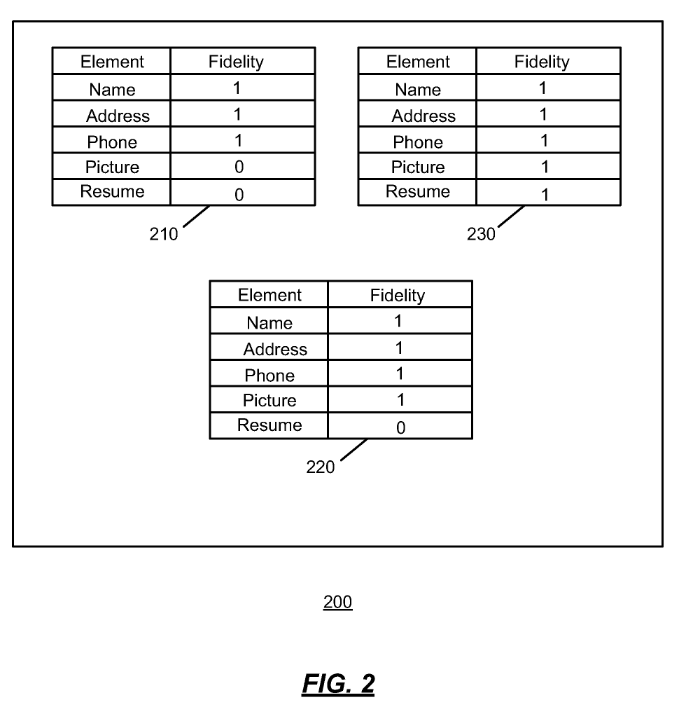

FIG. 2 is an illustration of a set 200 of exemplary fidelity tags. Fidelity tag 210 is an example of a fidelity tag for a contact file that supports the elements “Name”, “Address”, and “Phone” as indicated by the 1 after each field. Fidelity tag 220 is an example of a fidelity tag for a contact file that supports the elements “Name”, “Address”, “Phone”, and “Picture”. Similarly, fidelity tag 230 is for a contact file that supports the elements “Name”, “Address”, “Phone”, “Picture”, and “Resume”. In some implementations, the fidelity tag 230 is an example of a high-fidelity tag and indicates a high-fidelity item and fidelity tags 210 and 220 are examples of low-fidelity tags and indicate low-fidelity items.

The fidelity manager 105 may further associate each item with a tagged version number. In some implementations, a tagged version number may be a three tuple containing an identifier of a replica device (i.e., one of replica devices 110a-110e), an update count, and a fidelity tag. The update count may be independently maintained and specific to each of the replica devices 110a-110e. When one of replica devices 110a-110e performs an update on an item, the fidelity manager 105 at the updating replica device may replace the identifier of the replica with an identifier of the replica device that performed the update, and may adjust the update count to the update count of the replica device. The fidelity manager 105 may also adjust the fidelity tag of the item to reflect the fidelity of the replica device.

Hereinafter the tagged version numbers may be represented by a letter indicating the particular replica device 110a-110e followed by a number indicating the update count. In addition, the letter indicating the particular replica device 110a-110e may be underlined or non-underlined. An underlined replica device identifier may indicate that the item is a low-fidelity item, and a non-underlined replica identifier may indicate that the item is a high-fidelity item. For example, the tagged version number “A3” may represent a high-fidelity version of an item that was last updated at the laptop 110A for the third time. The tagged version number “B1” may represent a low-fidelity item that was updated for the first time at the server 110B.

The fidelity managers 105a-105e may further associate each item with a tagged version vector. A tagged version vector is a vector of tagged update counts. The tagged version vector may include an update count for each of the replica devices 110a-110e. Each time an item is updated at one of the replica devices 110a-110e, the update count for that replica A-E may be incremented. For example, an update count of three for the laptop 110A implies that the version of an item associated with the tagged version vector incorporates any update of the item performed at the laptop 110A with an update count less than or equal to three.

Hereinafter the tagged version vector may be represented by a letter and number pair corresponding to each of the replica devices 110a-110e that has updated the item. In addition, the letter may either be underlined or non-underlined representing the fidelity tag that the item had at the most recent update at that replica device. For example, a tagged version vector <A2B1E1> may represent an item that was updated twice at the laptop 110A, with the most recent update being a high-fidelity update of the item, was updated once as a high-fidelity version at the server 110B, and was updated once as a low-fidelity version at the cellular telephone E.

The tagged version numbers and tagged version vectors associated with two versions of an item may be used by the fidelity managers 105a-105e to determine which version of an item may supersede (i.e., replace) the other version of the item, if there is a conflict between two versions of an item that cannot be resolved or when a low-fidelity and a high-fidelity version of an item may be integrated.

To facilitate these operations, two partial orders may be defined on the tagged version vector. First, the tagged partial order, ≧t, represents supersession over tagged version numbers. An item with a tagged version vector v₁ supersedes an item with a tagged version vector v₂, if an only if:

(v₁[r]>v₂[r]) or (v₁[r]=v₂[r] and v₁[r].tag≧v₂[r].tag), for each replica device r.

Here, v[r] is the update count of the version vector element for the replica device r and v[r].tag is the corresponding fidelity tag for that replica device.

Second, the untagged partial order, ≧, may be an ordering over tagged version vectors that does not take into account the fidelity tags. That is v₁≧v₂, if and only if:

v₁[r]≧v₂[r], for each replica r.

As described above, the fidelity manager 105 is adapted to copy an item from the high-fidelity replication platform 109 to the low-fidelity replication platform 107. In one such scenario, a high-fidelity version of the item may be part of the high-fidelity replication platform 109, but is not part of the low-fidelity platform 107. In this scenario, the fidelity manager 105 may generate a low-fidelity version of the item by invoking an item specific application to reduce the fidelity of the high-fidelity version of the item to a low-fidelity version of the item. The fidelity manager 105 may generate a tagged version number for the low-fidelity version of the item from the tagged version number of the high-fidelity item by setting the fidelity tag of the tagged version number to the fidelity level of the low-fidelity replication platform 107. Further, the fidelity manager 105 may generate a tagged version vector for the low-fidelity version of item from the tagged version vector of the high-fidelity version of the item by setting the fidelity tag of each element in the tagged version vector to the fidelity level of the low-fidelity replication platform 107. The fidelity manager 105 may then provide the low-fidelity version of the item to the low-fidelity replication platform 107.

In another scenario, a low-fidelity version of the high-fidelity item already exists in the low-fidelity replication platform 107, but it has a different tagged version number than the high-fidelity version of the item. If the tagged version vector of the low-fidelity version of the item does not supersede the tagged version vector of the high-fidelity version of the item under the tagged partial order relationship defined above, the fidelity manager 105 may generate a new low-fidelity version of the item as described above in the first scenario and replace the low-fidelity version of the item in the low-fidelity replication platform 107 with the new low-fidelity version of the item if the high-fidelity version of the item's version vector supersedes the low-fidelity version of the item's version vector. If it does not, then the fidelity manager 105 may create a separate low-fidelity version of the item because there may be an application level conflict between the versions of the item, for example.

As described above, the fidelity manager 105 is also adapted to copy items from the low-fidelity replication platform 107 to the high-fidelity replication platform 109. In one scenario, a low-fidelity version of an item may be at the low-fidelity replication platform 107, but no such item exists in the high-fidelity replication platform 109 because the item was just created. In this scenario, the fidelity manager 105 may copy the low-fidelity version of the item to the high-fidelity replication platform 109 without making changes to the tagged version number or tagged version vector associated with the item.

In another scenario, a low-fidelity version of an item is in the low-fidelity replication platform 107 and a high-fidelity version of the item is in the high-fidelity replication platform 109. In addition, the tagged version vector of the low-fidelity version of the item does supersede the tagged version vector of the high-fidelity contact item under the untagged partial order relationship described above. In this scenario, the fidelity manager 105 may copy the low-fidelity version of the item to the high-fidelity replication platform 109, but may first integrate elements of the high-fidelity version of the item into the low-fidelity version of the item. An implementation of a process for integrating conflicting items by the fidelity manager 105 is described below.

The fidelity manager 105 may be further adapted to integrate updates made to conflicting versions of an item, v₁ and v₂. Because the environment 100 is weakly consistent, one or more of the replica devices 110a-110e may make conflicting updates to an item or may make updates to different version of an item. These conflicting updates may be made to a low and high-fidelity version of the item. Thus, the fidelity manager 105 may be invoked by either of the low-fidelity replication platform 107 and high-fidelity replication platform 109 when conflicting versions of an item are detected. In some implementations, the conflicting versions of an item may be detected by the high-fidelity replication platform 109 and the low-fidelity replication platform 107 as described above. In other implementations, the fidelity manager 105 may identify or detect the conflict, for example.

In an integration scenario, the fidelity manager 105 may determine that the tagged version vectors of the item v₁ and v₂ are equal. In this scenario, the detected conflict is a false conflict. For example, the fidelity managers 105 at one or more replica devices 110a-110e may have independently performed the same fidelity reduction on a high-fidelity version of an item or may have performed an item integration independently. In this scenario, the fidelity manager 105 may resolve the conflict by randomly selecting between the v₁ and v₂ versions of the item.

In another integration scenario, the fidelity manager 105 may determine that two conflicting versions of an item, v₁ and v₂, have tagged version vectors that are not equivalent, and neither version of the item has a version vector that supersedes the version vector of the other version of the item, either under the tagged partial order relationship or the untagged partial order relationship described above. In this scenario, the conflict is a true conflict and fidelity manager 105 may alert the low-fidelity replication platform 107 and the high-fidelity replication platform 109 of the conflict, or some other component may generate the alert, for example.

In another integration scenario, the fidelity manager 105 may determine that either the tagged version vector of the item v₁ or the tagged version vector of the item v₂ supersedes the tagged version vector of the other item according to the tagged partial order relationship. Accordingly, the fidelity manager 105 may choose the version of an item with the superseding tagged version vector.

In another integration scenario, the fidelity manager 105 may determine that the versions of the item, v₁ and v₂, have tagged version vectors where one of the tagged version vectors supersedes the other according to the untagged partial order relationship, but not the tagged partial order relationship. In this scenario, one of replica devices 110a-110e may have taken a low-fidelity version of a high-fidelity item from another one of replica devices 110a-110e, made a low-fidelity update to the item, and passed it back to the original one of replica devices 110a-110e. Thus, the fidelity manager 105 may integrate fields of the high-fidelity version of the item into the updated low-fidelity version of the item.

The fidelity manager 105 may create an integrated version of an item v from the versions of the item v₁ and v₂ by first making a copy of the least recent version of the item that has the most recent tagged version number, in this case v₂. The fidelity manager 105 may then copy the fields of v₁ that are not part of v₂ as indicated by the fidelity tags of v₁ and v₂. For example, v₁ may be a high-fidelity version of v and v₂ may be a low-fidelity version of v. As described previously with respect to FIG. 2 for example, a fidelity tag may indicate the elements of an item that are supported at a particular fidelity level. Thus, the item v₁ has more elements than the item v₂ because it is a higher fidelity item.

The fidelity manager 105 may set the tagged version number of the new version of v to the same tagged version number associated with v₂, and merge the tagged version vectors of v₁ and v₂ to generate a new tagged version vector. In some implementations, the fidelity manager 105 may merge the tagged version vectors by comparing the tagged version vectors element by element and keeping the tag and version number of the superior tagged version number, for example.

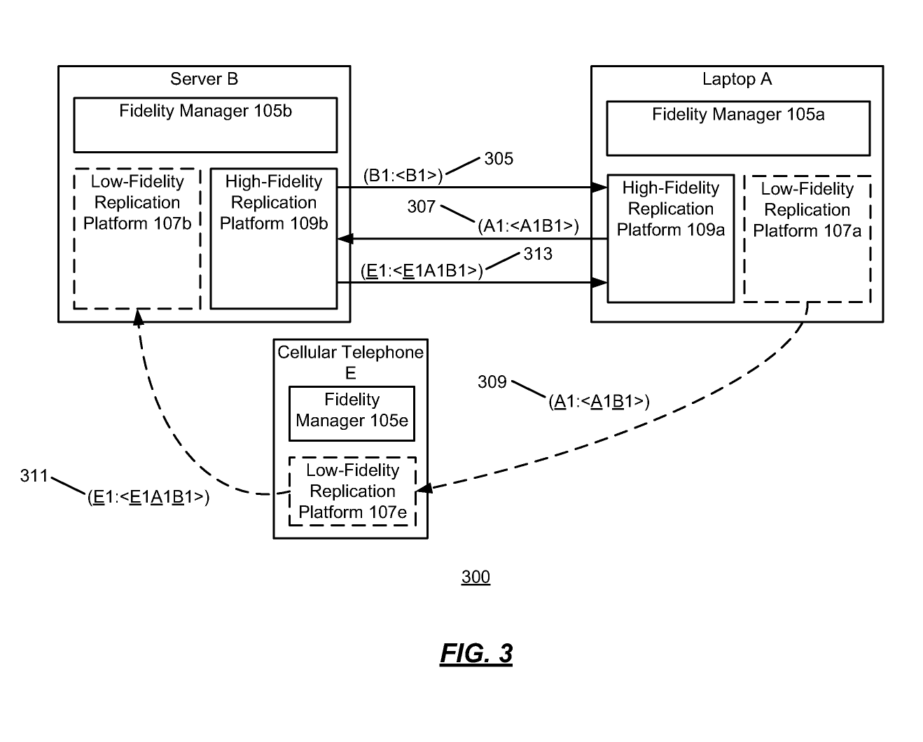

FIG. 3 is an illustration of an exemplary environment 300 for providing fidelity-aware replication. The environment 300 is substantially similar to the environment 100 illustrated in FIG. 1, except having only the replica devices corresponding to laptop 110a, server 110b, and cellular telephone 110e. The environment 300 will be used to describe example fidelity reduction and integration operations.

An item may be generated by the server 110b. The fidelity manager 105b at the server 110b may then generate a tagged version number and tagged version vector 305 for the item. As illustrated, the tagged version number and version vector 305 for the item is B1:<B1>. The item may be a high-fidelity item as indicated by the high-fidelity tagged version vector and tagged version number. The fidelity manager 105b at the server 110b may provide the item and tagged version number and version vector 305 to the high-fidelity replication platform 109b at the server 110b where it may be replicated to the high-fidelity replication platform 109a at the laptop 110a, for example.

An update may be made to the item at the laptop 110a. For example, a user at the laptop may alter or change the item. Accordingly, the fidelity manager 105a may replace the tagged version number and version vector 305 with the tagged version number and version vector 307 to reflect the update. As illustrated the tagged version vector and version number 307 for the updated item is A1:<A1B1>. The fidelity manager 105a may provide the item and updated tagged version number and tagged version vector to the high-fidelity replication platform 109a at the laptop 110a where it may be replicated to the high-fidelity replication platform 109b at the server 110b, for example.

In addition, the fidelity manager 105a may generate a reduced fidelity version of the item for the low-fidelity replication platform 107a. The fidelity manager 105a may generate the low-fidelity version of the item by invoking an application or process that is specific to the type of the item. For example, where the item is a contact, the fidelity manager 105a may invoke an application that is designed to reduce the fidelity of contact items.

Further, the fidelity manager 105a may generate a new tagged version number and tagged version vector 309 to reflect the reduction in fidelity. As illustrated, the tagged version number and version vector 309 is A1:<A1B1>. The fidelity manager 105a may provide the item and tagged version number and tagged version vector 309 to the low-fidelity replication platform 107a of the laptop 110a, where it may be replicated to the low-fidelity replication platform 107e at the cellular telephone 110e as part of the synchronization process.

The item and tagged version number and version vector 309 may be received at the cellular telephone 110e. A user at the cellular telephone 110e may make an update to the item that is identified by the fidelity manager 105e at the cellular telephone 110e. Accordingly, the fidelity manager 105e may generate a new tagged version number and tagged version vector 311 to reflect the update to the item. As illustrated, the new tagged version number and tagged version vector 311 is E1:<E1A1B1>, for example. The fidelity manager 105e may provide the item and tagged version number and tagged version vector 311 to the low-fidelity replication platform 107e of the cellular telephone E, where it may be replicated to the low-fidelity replication platform 107b of the server 110b as part of the synchronization process.

The item and the tagged version number and tagged version vector 311 is received by the fidelity manager 105b of the server 110b, and the fidelity manager 105b may attempt to reintegrate the changes made to the low-fidelity version of the item described by the tagged version number and tagged version vector 311 with the high-fidelity version of the item described by the tagged version number and tagged version vector 307.

Accordingly, the fidelity manager 105b of the server 110b may copy the high-fidelity elements of the item having the tagged version number and tagged version vector 311 into the item (or a copy of the item) having the tagged version number and tagged version vector 307, resulting in a new version of the item having both high and low-fidelity elements. The fidelity manager 105b of the server 110b may further set the tagged version number of the new version of the item to the tagged version number of the most recent version of the item (i.e., E1) and generate a new tagged version vector by merging the tagged version vectors of the two version of the item and keeping the superior elements from each tagged version vector. As illustrated, the new tagged version number and tagged version vector 313 is E1:<E1A1B1>. The fidelity manager 105b of the server 110b may then copy the new version of the item with the tagged version number and tagged version vector 313 to the high-fidelity replication platform 109b, and the new version of the item with the tagged version number and tagged version vector 313 may then be replicated to the high-fidelity replication platform 109a of the laptop 110a as part of the synchronization process.

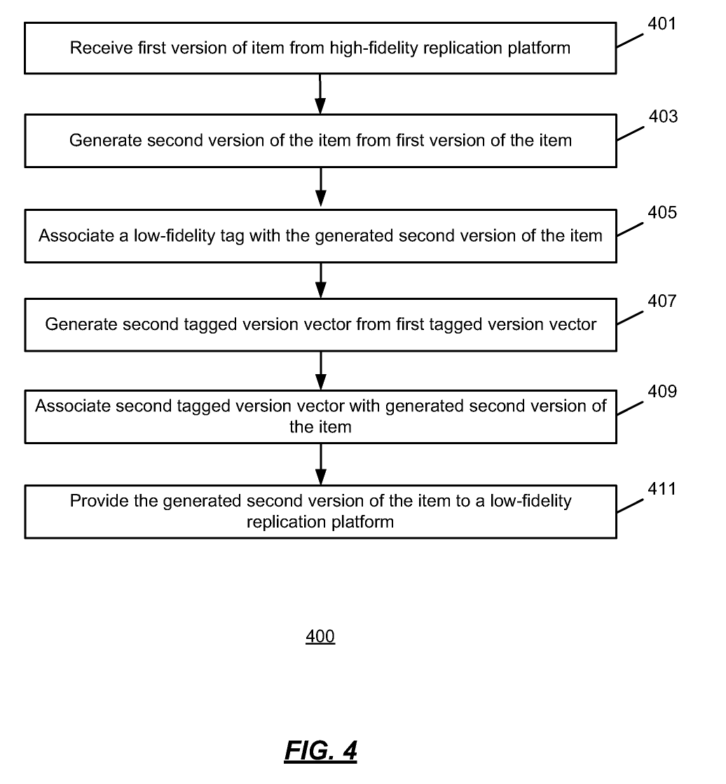

FIG. 4 is an illustration of an exemplary process 400 for transforming a high-fidelity version of an item into a low-fidelity version of the item. In some implementations, the process 400 may be implemented by the fidelity manager 105, for example.

A first version of an item may be received from a high-fidelity replication platform (401). In some implementations, the first version of an item may be received by the fidelity manager 105 from the high-fidelity replication platform 109 executed by one of the replica devices 110a-110e, for example. The item may be a content file or another type of file. The first version of the item may have an associated tagged version number and tagged version vector. The tagged version vector may include a count value and fidelity value for each of one or more replica devices (e.g., replica devices 110a-110e). The count value for a replica device may define the number of updates made by the replica device to the first version of the item, and the fidelity value for a replica device may define the fidelity at which the most recent update was made by the replica device.

A second version of the item may be generated from the first version of the item (403). In some implementations, the second version of the item may be generated by the fidelity manager 105. The first version of the item may be a high-fidelity version of the item and the second version of item may be a low-fidelity version of the item. In some implementations, the second version of the item may be generated by removing fields or elements from the first version of the item that are not supported by low-fidelity applications that may use or update the second version of the item.

A low-fidelity tag may be associated with the generated second version of the item (405). In some implementations, the low-fidelity tag may be associated with the second version of the item by the fidelity manager 105. The low-fidelity tag may be tagged version number. A flag, vector, or other data structure may be used to indicate that the tag is a low-fidelity tag.

A second tagged version vector may be generated from the first tagged version vector (407). In some implementations, the second tagged version vector may be generated by the fidelity manager 105. The second tagged version vector may be generated by changing the fidelity values in the first version vector to low-fidelity values, for example.

The second tagged version vector may be associated with the generated second version of the item (409). In some implementations, the second tagged version vector may be associated with the generated second version of the item by the fidelity manager 105. The second tagged version vector may be associated with the generated second version of the item by adding the second tagged version vector to the second version of the item as metadata. In other implementations, the second tagged version vector may be associated with the second version of the item by adding the second tagged version vector to a list or database that associates tagged version vectors with items, for example.

The generated second version of the item may be provided to a low-fidelity replication platform (411). In some implementations, the fidelity manager 105 may provide the generated second version of the item to a low-fidelity replication platform 109 executing at one of the replica devices 110a-110e. The low-fidelity replication platform 109, as part of the synchronization process, may provide the generated second version of the item to other low-fidelity replication platforms executing at one or more of the replica devices 110a-110e. The users at the replica devices 110a-110e may make one or more updates to the second version of the item, and the updated second version of the item may be returned to the low-fidelity replication platform 109 as part of the synchronization process, for example.

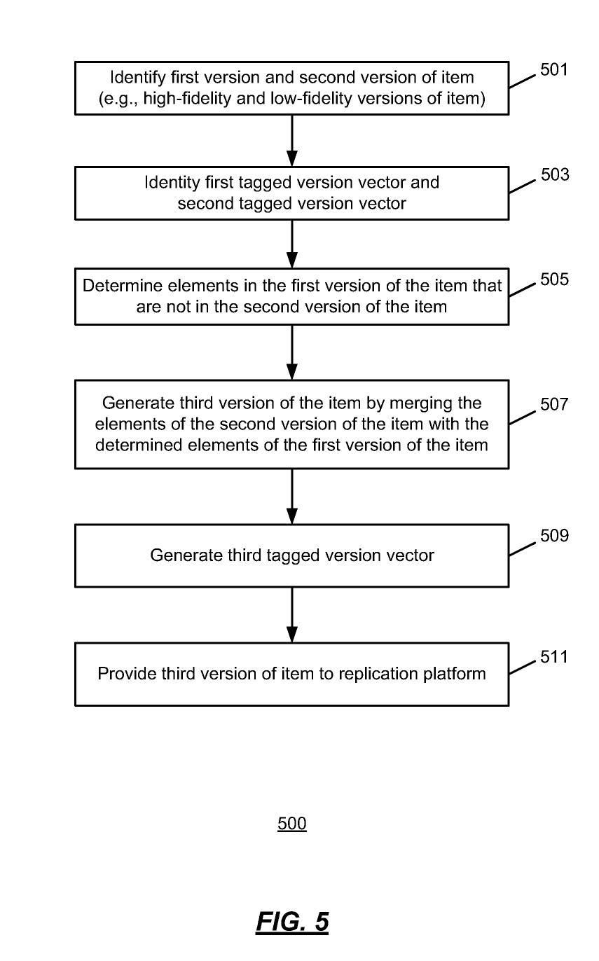

FIG. 5 is an illustration of an exemplary process 500 for integrating changes made to different versions of an item. The process 500 may be implemented by the fidelity manager 105 of one or more of the replica devices 110a-110e, for example.

A first version of an item and a second version of an item may be identified (501). In some implementations, the first version of the item and the second version of the item may be identified by the fidelity manager 105. The first version of the item may be a high-fidelity version of the item and the second version of the item may be a low-fidelity version of the item. The fidelity manager 105 may identify the first version of the item in the high-fidelity replication platform 109 and may identify the second version of the item in the low-fidelity replication platform 107, for example.

In some implementations, the first version of the item may be identified by the fidelity manager 105 when it is received by a high-fidelity replication platform 109. The fidelity manager 105 may identify the second version of the item in a low-fidelity replication platform 107 when the fidelity manager 105 attempts to copy the first version of the item to the low-fidelity replication platform 107, for example.

A first tagged version vector and a second tagged version vector may be identified (503). In some implementations, the first and second tagged version vectors may identified by the fidelity manager 105. The first and second tagged version vectors may be part of the metadata of the first and second versions of the item or may be identified from a database at the fidelity manager 105, for example. In some implementations, each tagged version vector may include a count value and a fidelity value for each of the replica devices 110a-110e. The count value for a replica device may define the number of updates made by one of replica devices 110a-110e to the corresponding version of the item and the fidelity value for one of replica devices 110a-110e may define the fidelity at which the most recent update was made by the particular one of replica devices 110a-110e.

Elements in the first version of the item that are not in the second version of the item may be determined (505). In some implementations, the elements may be determined by the fidelity manager 105 from tagged version numbers associated with the first and second versions of the item. For example, the high-fidelity first version of the item may support more elements than the low-fidelity second version of the item.

A third version of the item may be generated by merging the elements of the second version of the item with the determined elements (507). In some implementations, the third version of the item may be generated by the fidelity manager 105, for example.

A third tagged version vector may be generated (509). In some implementations, the third tagged version vector may be generated by the fidelity manager 105. The third version vector may be generated by, for each count value in the first version vector, comparing the count value in the first version vector with the count value in the second version vector corresponding to the same replica device. If the count value is higher in the first version vector, then the count value and the fidelity value from the first version vector are used in the third version vector, and if the count value is higher in the second version vector, then the count value and the fidelity value from the second version vector are in the third version vector.

A third version of the item may be provided to a replication platform (511). In some implementations, the third version of the item may be provided by the fidelity manager 105 to a replication platform, such as the high-fidelity replication platform 109. The third version vector may also be provided along with the third version of the item to the replication platform.

FIG. 6 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers (PCs), server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610. Computing device 600 typically includes a variety of computer readable media. Computer readable media can be any available media that can be accessed by device 600 and include both volatile and non-volatile media, and removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communications connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the processes and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include PCs, network servers, and handheld devices, for example. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for integrating updates to items in a topology-independent weakly consistent replication system, comprising:
identifying a first version of an item and a second version of the item at a fidelity manager, the first version of the item having a higher fidelity than the second version of the item and the second version of the item being more recently updated than the first version of the item;
determining a plurality of elements in the first version of the item that are not in the second version of the item at the fidelity manager; and
generating a third version of the item by merging the elements of the second version of the item with the determined elements of the first version of the item that are not in the second version of the item at the fidelity manager, wherein the third version of the item has the fidelity of the first version of the item.

2. The method of claim 1, wherein the first version of the item is a high-fidelity item and the second version of the item is a low-fidelity item.

3. The method of claim 1, wherein the first version and the second version each have an associated fidelity tag that identifies the elements in the item, and determining the elements in the first version of the item that are not in the second version of the item comprises comparing the fidelity tag of the first version of the item with the fidelity tag of the second version of the item.

4. The method of claim 1, further comprising identifying a first tagged version vector associated with the first version of the item and a second tagged version vector associated with the second version of the item at the fidelity manager, wherein each tagged version vector comprises a count value and a fidelity value for each of a plurality of replica devices, the count value for a replica device defining a number of updates made by the replica device to the corresponding version of the item and the fidelity value for a replica device defining the fidelity at which the most recent update was made by the replica device.

5. The method of claim 4, further comprising generating a third tagged version vector for the generated third version of the item by, for each count value in the first tagged version vector:
comparing the count value in the first tagged version vector with the count value in the second tagged version vector corresponding to the same replica device;
if the count value is higher in the first tagged version vector, then using the count value and the fidelity value from the first tagged version vector in the third tagged version vector; and
if the count value entry is higher in the second tagged version vector, then using the count value and the fidelity value from the second tagged version vector in the third tagged version vector.

6. The method of claim 5, further comprising providing the third version vector to a replication platform.

7. The method of claim 1, further comprising providing the third version of the item to a replication platform.

8. The method of claim 1, further comprising receiving the first version of the item and the second version of the item from a replication platform.

9. A weakly consistent system for replicating an item comprising:
a first-fidelity level item replication platform adapted to replicate a first-fidelity level version of an item at a plurality of first-fidelity level replica devices;
a second-fidelity level item replication platform adapted to replicate a second-fidelity level version of the item at a plurality of second-fidelity level replica devices; and
a fidelity manager adapted to:
receive the first-fidelity level version of the item from the first-fidelity level item replication platform;
generate the second-fidelity level version of the item from the first-fidelity level version of the item; and
provide the second-fidelity level version of the item to the second-fidelity level item replication platform.

10. The system of claim 9, wherein the first-fidelity level is a high-fidelity level and the second-fidelity level is a low-fidelity level.

11. The system of claim 9, wherein the second-fidelity level version of the item and the first-fidelity level version of the item each comprise a plurality of elements and the fidelity manager is further adapted to:
receive the second-fidelity level version of the item from the second-fidelity level item replication platform, the second-fidelity level item having been updated at one or more of the second-fidelity level replica devices;
determine the elements of the plurality of elements of the first-fidelity level version of the item that are not elements of the second-fidelity level version of the item; and
generate a new first-fidelity level version of the item by integrating the determined elements with the elements of the second-fidelity level version of the item.

12. The system of claim 11, wherein the fidelity manager is further adapted to provide the new first-fidelity level version of the item to the first-fidelity level replication platform.

13. The system of claim 9, further comprising an additional fidelity level item replication platform adapted to replicate an additional fidelity level version of the item at a plurality of additional fidelity level replica devices, wherein the fidelity manager is further adapted to generate the additional fidelity level version of the item from the first-fidelity level version of the item and provide the additional fidelity level version of the item to the additional fidelity level item replication platform.

14. The system of claim 13, wherein the fidelity manager is further adapted to receive the second-fidelity level version of the item from the second-fidelity level item replication platform, generate the additional fidelity level version of the item from the second-fidelity level version of the item, and provide the additional fidelity level version of the item to the additional fidelity level item replication platform.

15. A method for integrating items in a weakly consistent replication system, comprising:
receiving a first version of an item at a fidelity manager from a first-fidelity level replication platform, the first version of the item having a first-fidelity version tag and a first tagged version vector, wherein a tagged version vector comprises a count value and fidelity value for each of a plurality of replica devices, the count value for a replica device defining a number of updates made by the replica device to an item and the fidelity value for a replica device defining the fidelity level at which a most recent update was made by the replica device;
generating a second version of the item using the first version of the item;
associating a second-fidelity level tag with the second version of the item;
generating a second tagged version vector using the first tagged version vector;
associating the second tagged version vector with the second version of the item; and
providing the second version of the item to a second-fidelity level replication platform.

16. The method of claim 15, wherein the first-fidelity level is a high-fidelity level and the second-fidelity level is a low-fidelity level.

17. The method of claim 15, further comprising
receiving the second version of the item from the second-fidelity level replication platform;
integrating the first version of the item into the second version of the item;
associating a first-fidelity level tag with the second version of the item; and
providing the second version of the item to the first-fidelity level replication system.

18. The method of claim 17, wherein the first-fidelity level tag identifies a plurality of elements of the first version of the item and the second-fidelity level tag identifies a plurality of elements of the second version of the item, and integrating the first version of the item into the second version of the item comprises:
determining from the first-fidelity level tag and the second-fidelity level tag the elements of the first version of the item that are not part of the second version of the item; and
integrating the determined elements into the second version of the item.

19. The method of claim 15, further comprising merging the first tagged version vector with the second tagged version vector to create a third tagged version vector.

20. The method of claim 19, wherein merging the first tagged version vector with the second tagged version vector comprises:
for each count value in the first tagged version vector:
comparing the count value in the first tagged version vector with the count value in the second tagged version vector corresponding to the same replica device;
if the count value is higher in the first version vector, then using the count value and the fidelity value from the first tagged version vector in the third tagged version vector; and
if the count value is higher in the second tagged version vector, then using the count value and the fidelity value from the second tagged version vector.
